(19) United States
(12) Patent Application Publication
(10) Pub. No.: US 2011/0317214 A1
(43) Pub. Date: Dec. 29, 2011

(54) SERVER APPARATUS, IMAGE FORMING SYSTEM, AND METHOD OF MANAGING IMAGE FORMING DATA

(75) Inventors: Yusuke Hamada, Shizuoka-ken (JP); Kazuhiro Ogura, Kanagawa-ken (JP); Shinji Makishima, Shizuoka-ken (JP); Akihiro Mizutani, Shizuoka-ken (JP); Toshihiro Ida, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/169,102

(22) Filed: Jun. 27, 2011

Related U.S. Application Data
(60) Provisional application No. 61/359,180, filed on Jun. 28, 2010.

(51) Int. Cl. G06K 15/02

(52) U.S. Cl. 358/1.15

(57) ABSTRACT

According to one embodiment, a server apparatus includes a storage unit, a communication unit, and a controller. The storage unit stores print jobs received from an external apparatus. The communication unit transmits the print job stored in the storage unit, in response to a print request for the print job from any image forming apparatus, to the image forming apparatus which is a print request source. The controller changes the print job of which a storage limit expires among the print jobs stored in the storage unit into a deleted print job so as to have a temporary storage limit.

### CROSS-REFERENCE TO RELATED APPLICATIONS

This application is based upon and claims the benefit of priority from U.S. Provisional Application No. 61/359,180 filed on Jun. 28, 2010; the entire contents of which are incorporated herein by reference.

### FIELD

Embodiments described herein relate generally to a server apparatus, an image forming system, and a method of managing image forming data.

### BACKGROUND

An image forming system accumulates print data set by a client PC in a server apparatus and reads the print data accumulated in the server apparatus from an image forming apparatus to form an image. In such an image forming system, a server apparatus according to the related art deletes print data, for which a predetermined storage limit expires from the accumulation of the print data, and printed print data.

### BRIEF DESCRIPTION OF THE DRAWINGS

FIG. 1 is a diagram schematically illustrating an example of the configuration of an image forming system.

FIG. 2 is a block diagram illustrating an exemplary configuration of the control systems of a client PC, a print server, a temporary storage apparatus, and an image forming apparatus.

FIG. 3 is a diagram illustrating an example of the structure of a job management table.

FIG. 4 is a diagram illustrating an example of the structure of a deleted job management table.

FIG. 5 is a diagram illustrating an example of first setting of a storage limit and a temporary storage limit.

FIG. 6 is a diagram illustrating an example of second setting of a storage limit and a temporary storage limit.

FIG. 7 is a diagram schematically illustrating an example of a second configuration of the image forming system.

FIG. 8 is a block diagram illustrating a second exemplary configuration of the control system of each apparatus in the image forming system.

FIG. 9 is a diagram schematically illustrating a third exemplary configuration of the image forming system.

FIG. 10 is a block diagram illustrating a third exemplary configuration of the control system of each apparatus in the image forming system.

FIG. 11 is a third exemplary management table in a print server.

FIG. 12 is a flowchart illustrating a process of managing print jobs in the print server.

FIG. 13 is a flowchart illustrating a process of managing deleted print jobs in the temporary storage apparatus.

FIG. 14 is a flowchart illustrating a process of printing the print jobs and the deleted print jobs in the image forming apparatus.

FIG. 15 is a diagram illustrating a first display example of a list of the normal print jobs.

FIG. 16 is a diagram illustrating a first display example of a list of the deleted print jobs.

FIG. 17 is a diagram illustrating a second display example of the list of the normal print jobs.

FIG. 18 is a diagram illustrating a second display example of the list of the deleted print jobs.

FIG. 19 is a diagram illustrating a third display example of the list of the normal print jobs.

FIG. 20 is a diagram illustrating a display example of a mixed list of the normal print jobs and the deleted print jobs.

### DETAILED DESCRIPTION

In general, according to one embodiment, a server apparatus includes a storage unit, a communication unit, and a controller. The storage unit stores print jobs received from an external apparatus. The communication unit transmits a print job stored in the storage unit, in response to a print request for the print job from any image forming apparatus, to the image forming apparatus which is a print request source. Among the print jobs stored in the storage unit, the controller changes the print job of which a storage limit expires into a deleted print job so as to have a temporary storage limit.

Hereinafter, embodiments will be described in detail with reference to the drawings.

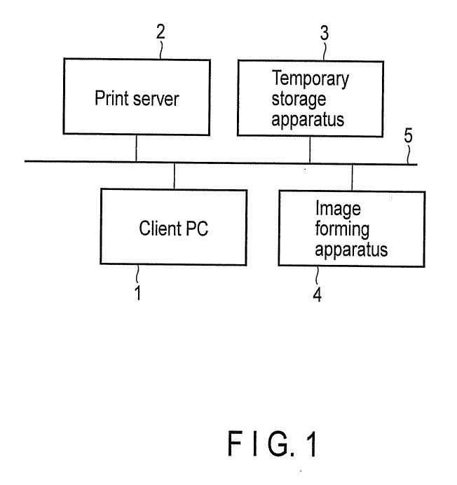

FIG. 1 is a diagram schematically illustrating an exemplary configuration of an image forming system.

In the exemplary configuration shown in FIG. 1, the image forming system includes a plurality of client PCs 1, a print server 2, a temporary storage apparatus 3, and a plurality of image forming apparatuses 4. In the image forming system, the respective client PCs 1, the print server 2, and the respective image forming apparatuses 4 are connected to a network 5. The network 5 is constructed by wired or wireless communication. The network 5 is not limited to a network in a local area network. For example, the network 5 may include a broad area network such as the Internet.

The image forming system is a system (referred to as a PULL print system) that has a function (referred to as PULL print) of accumulating the print jobs requested from the client PCs 1 by users in the print server 2 and performing the accumulated print jobs stored in the print server 2 in response to an operation executed on the image forming apparatuses 4 by the users.

The client PC 1 is a terminal apparatus that is used by the user. For example, the client PC 1 is a personal computer. The client PC 1 may be an apparatus that transmits the print job for the PULL print to the print server 2 via the network 5.

For example, the client PC 1 may be a portable terminal apparatus. The client PC 1 has a user identification function of acquiring user identification information used to uniquely identify the user. In this embodiment, it is assumed that the client PC 1 acquires the user identification information when giving an instruction for at least the PULL print.

The client PC 1 operates a printer driver program (hereinafter, referred to as a printer driver) for the PULL print in response to a printing instruction from the user. In the client PC 1, a processor operates the printer driver to generate a job file (hereinafter, simply referred to as a print job) that includes data and print setting contents for a print target instructed by the user. The client PC 1 stores the user identification information in the job file. The client PC 1 transmits the generated job file to the print server 2.

Further, the user identification information may be specified by the print server 2. For example, the print server 2 may be configured to specify the user identification information based on information acquired from the client PC 1 connected to transmit the job file.

The print server 2 is configured by a server computer. The print server 2 has a function of communicating with each client PC 1, the temporary storage apparatus 3, and each image forming apparatus 4 via the network 5. The print server 2 accumulates the job files as the print jobs requested from the client PCs 1. The print server 2 stores the job files by associating the job files with the user identification information indicating the users and information such as the request time for a job.

The print server 2 manages the job file during a predetermined storage limit. For example, the print server 2 automatically deletes the job file after the predetermined storage limit expires. The print server 2 moves the job file to be deleted due to the expiration of the storage limit to the temporary storage apparatus 3. That is, when the storage limit for a given job file expires, the print server 2 stores the job file in the temporary storage apparatus 3 as a deleted print job by performing the process of moving the job file from the print server 2 to the temporary storage apparatus 3 and deletes the job file from the print server 2.

Further, the print server 2 receives job queries designating the users (user identification information) from any image forming apparatus 4 connected to the network 5. The print server 2 extracts the print jobs (the job files) corresponding to the user identification information designated by the queries. The print server 2 transmits a list of the extracted job files to the corresponding image forming apparatus 4.

Further, the print server 2 receives a transmission (printing) request for the job file from the image forming apparatus 4. The print server 2 reads the job file designated in response to the transmission request and transmits the read job file to the corresponding image forming apparatus 4. When the print server 2 transmits the job file to the image forming apparatus 4, the print server 2 moves the job file transmitted to the image forming apparatus 4 as a deleted job file created by the printing to the temporary storage apparatus 3. The print server 2 may receive a print completion notification for the job file from the image forming apparatus 4 transmitting the job file, and then may move the job file to the temporary storage apparatus 3.

For example, the temporary storage apparatus 3 is configured by a computer. The temporary storage apparatus 3 has a function of communicating with the print server 2 and each image forming apparatus 4 via the network 5. The temporary storage apparatus 3 stores the job file (deleted print job) deleted by the print server 2 after the expiration of the storage limit or the printing. The temporary storage apparatus 3 stores the job files (the deleted print jobs) by associating the job files with the user identification information indicating the user and information such as the request time for a job.

The temporary storage apparatus 3 manages the job files during the temporary storage limit. That is, the temporary storage apparatus 3 automatically deletes each job file after the temporary storage limit expires. The temporary storage limit (temporary storage period) may be set for each job file. For example, the temporary storage apparatus 3 stores the print jobs deleted after the expiration of the storage limit by the print server 2 during a first temporary storage limit and also stores the print jobs deleted after the printing by the print server 2 during a second temporary storage limit. The first and second temporary storage limits may be set by an administrator.

Further, the print jobs deleted after the expiration of the storage limit may not be stored in the temporary storage apparatus 3 by setting the first temporary limit to “0”. Alternatively, the print jobs deleted after the printing may not be stored in the temporary storage apparatus 3 by setting the second temporary limit to “0”.

The temporary storage apparatus 3 receives job queries designating the users (user identification information) from any image forming apparatus 4 connected to the network 5. The temporary storage apparatus 3 extracts the deleted print jobs (the print jobs being temporarily stored) corresponding to the user identification information designated by the queries. The temporary storage apparatus 3 transmits a list of the extracted print jobs (the job files) to the corresponding image forming apparatus 4.

Further, the temporary storage apparatus 3 receives a transmission (printing) request for the job file from the image forming apparatus 4 transmitting the list of the job files. The temporary storage apparatus 3 reads the job file designated in response to the transmission request and transmits the read job file to the corresponding image forming apparatus 4. When the temporary storage apparatus 3 transmits the job file to the image forming apparatus 4, the temporary storage apparatus 3 deletes the job file transmitted to the image forming apparatus 4. When the temporary storage apparatus 3 transmits the job file to the image forming apparatus 4, the temporary storage apparatus 3 may again (newly) set the temporary storage limit in the job file transmitted to the image forming apparatus 4. The temporary storage apparatus 3 may receive a print completion notification of the job file from the image forming apparatus 4 transmitting the job file, and then may delete or again store the job file.

Each image forming apparatus 4 is configured by a digital multi function peripheral (MFP). The image forming apparatus 4 has a printer function, a network communication function, and a user identification (user authentication) function. The image forming apparatus 4 acquires user identification information used to identify the user as an operator through the user identification function. The user identification information may be information by which the print server 2 can determine the user associated with the job. For example, the user identification information may be a user ID that is input by an operator when the operator logs in the image forming apparatus 4 or may be information that can be acquired as the result of the user authentication process using authentication information such as a password or a biological information input by the operator.

When the PULL print is executed on the job file within the storage limit, the image forming apparatus 4 queries the print server 2 the print job executable by the user identified by the user identification function. For example, the image forming apparatus 4 transmits a query for the job file corresponding to the user identification information acquired by the user identification function to the print server 2 via the network 5. The image forming apparatus 4 displays the list of the job files transmitted from the print server 2 in response to the query as the job files executable by the user.

The image forming apparatus 4 gives the print server 2 a transmission (printing) request for the job file selected from the displayed list of the job files by the user. When the image forming apparatus 4 receives the job file transmitted from the print server 2 in response to the transmission (printing) request, the image forming apparatus 4 performs the printing based on the corresponding job file. When the image forming apparatus 4 completes the printing, the image forming apparatus 4 may notify the print server 2 with information indicating the printing completion.

Further, when the image forming apparatus 4 performs the deleted print job, the image forming apparatus 4 designates the user identification information and queries the temporary storage apparatus 3 (or the print server 2) on the deleted print job. The image forming apparatus 4 displays the list of the deleted job files transmitted from the temporary storage apparatus 3 (or the print server 2) in response to the query as the deleted job files executable by the user.

The image forming apparatus 4 gives the temporary storage apparatus 3 a transmission (printing) request for the deleted job file selected from the displayed list of the deleted job files by the user. When the image forming apparatus 4 receives the deleted job file transmitted from the temporary storage apparatus 3 in response to the transmission (printing) request, the image forming apparatus 4 performs the printing based on the job file. When the image forming apparatus 4 completes the printing, the image forming apparatus 4 may notify the temporary storage apparatus 3 (or the print server 2) with information indicating the printing completion.

Next, the configuration of the control systems of the client PC 1, the print server 2, the temporary storage apparatus 3, and the image forming apparatus 4 will be described.

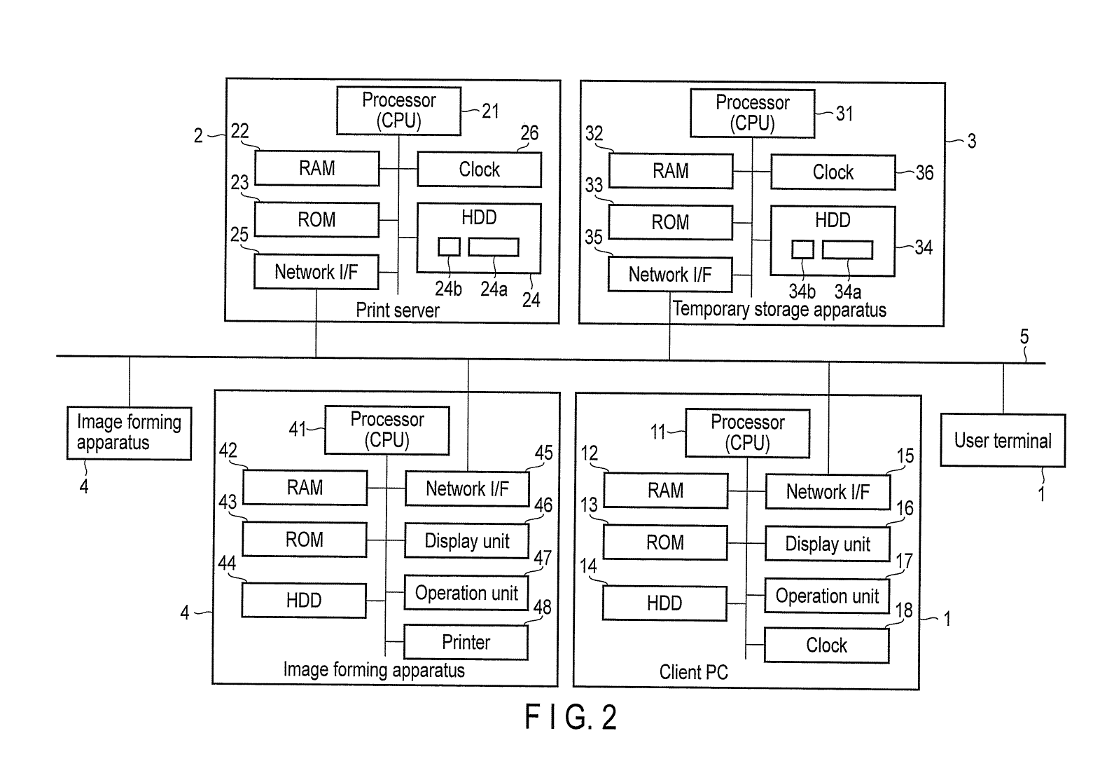

FIG. 2 is a block diagram illustrating an exemplary configuration of the control systems of the client PC 1, the print server 2, the temporary storage apparatus 3, and the image forming apparatus 4.

First, the configuration of the client PC 1 will be described.

As shown in FIG. 2, each client PC 1 includes a processor (CPU) 11, a RAM 12, a ROM 13, an HDD 14, a network interface (I/F) 15, a display unit 16, an operation unit 17, and a clock 18.

For example, the processor 11 is a CPU. The processor 11 controls the entire client PC 1. The processor 11 realizes various kinds of processing functions by executing programs stored in the ROM 13 or the HDD 14. The RAM 12 is a working memory. The ROM 13 stores a control program, control data, or the like for controlling the basic operations of the client PC 1. The HDD 14 is a storage device that stores data. For example, the HDD 14 stores data such as an image to be printed, an application program (for example, a printer driver) executed by the processor 11, user authentication data, and the like.

The network interface 15 is an interface that executes data communication with each of the apparatuses connected to the network 5. The display unit 16 displays an operation guide or the like. For example, the display unit 16 displays a print setting screen (print instruction screen) when the processor 11 executes the printer driver. The operation unit 17 is used when a user inputs information. For example, the operation unit 17 is configured by a keyboard and a mouse, or a touch panel provided in the display unit 16. The clock 18 counts a current time.

In the client PC 1, the processor 11 realizes the user identification function by executing a program. The user identification function may be a user ID input by the user in a log-in process or user information acquired through an identification process with authentication information such as a password. For example, the user inputs the user ID in the log-in process of the user when the client PC 1 is operated. The user identification information may be acquired by a user authentication process executed when the user instructs the PULL print.

In the client PC 1, the processor 11 receives the user setting and registration of the PULL print by executing the printer driver for performing the PULL print. For example, the processor 11 displays the print setting screen of the PULL print on the display unit 16 by executing the printer driver and receives print setting contents of the operation unit 17 from the user. When the user instructs to execute (register) the PULL print, the processor 11 generates the job file (print data) indicating the print contents and transmits the generated job file to the print server 2.

Next, the configuration of the print server 2 will be described.

As shown in FIG. 2, the print server 2 includes a processor (CPU) 21, a RAM 22, a ROM 23, an HDD 24, and a network interface (I/F) 25, and a clock 26.

For example, the processor 21 is a CPU. The processor 21 controls the entire print server 2. The processor 21 realizes various kinds of processing functions by executing programs stored in the ROM 23 or the HDD 24. The processor 21 executes a program to realize a management function of managing a job which is supplied from the client PC 1 and is printed by the image forming apparatus 4. The RAM 22 is a working memory. The ROM 23 stores a control program, control data, or the like for controlling the basic operations of the print server 2. The network interface 25 is an interface that executes data communication with each of the apparatuses connected to the network 5. The clock 26 counts a current time.

The HDD 24 is a storage device that stores data. The HDD 24 stores a program that is executed by the processor 21 to realize the management function of managing the job indicated by the job file. Further, the HDD 24 includes a storage region 24a that stores the job file indicating the details of the job and a job management table 24b that stores management information for the job file.

In the system configuration shown in FIG. 1, the storage region 24a stores the job file that is ready to be printed within the storage limit. The job management table 24b stores the management information regarding the job file that is stored in the storage region 24a and is ready to be printed within the storage limit.

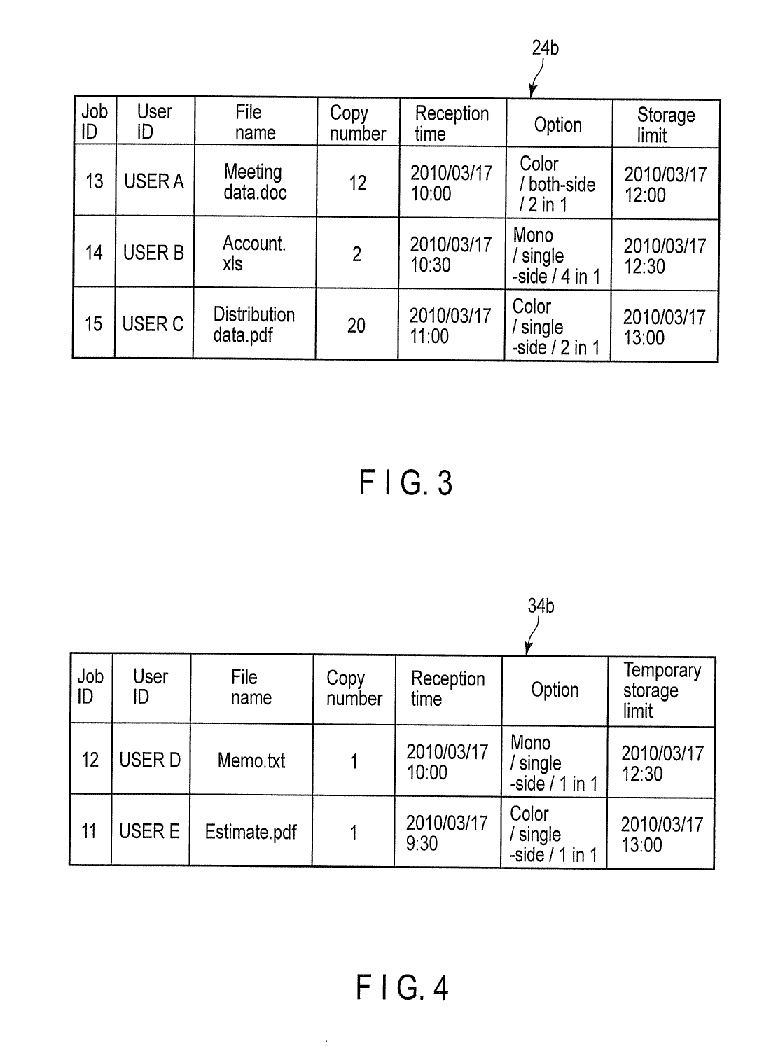

FIG. 3 is a diagram illustrating an example of the structure of the job management table 24b.

In the example shown in FIG. 3, a job ID, a user ID, a job file name, a copy number, a reception time, an option, and a storage limit are stored for each print job in association therewith in the job management table 24b. In the example shown in FIG. 3, a storage period for each print job is set to be 2 hours. In the example shown in FIG. 3, the storage limit is set for all of the print jobs based on the predetermined storage period. However, the storage period may be set by an administrator or may be set under the conditions of the print job.

Next, the configuration of the temporary storage apparatus 3 will be described.

As shown in FIG. 2, the temporary storage apparatus 3 includes a processor (CPU) 31, a RAM 32, a ROM 33, an HDD 34, and a network interface (I/F) 35, and a clock 36.

For example, the processor 31 is a CPU. The processor 31 controls the entire temporary storage apparatus 3. The processor 31 realizes various kinds of processing functions by executing programs stored in the RAM 33 or the HDD 34. The processor 31 executes a program to realize a management function of managing the deleted print job to store the deleted print job deleted in the print server 2. The RAM 32 is a working memory. The ROM 33 stores a control program, control data, or the like for controlling the basic operations of the temporary storage apparatus 3. The network interface 35 is an interface that executes data communication with each of the apparatuses connected to the network 5. The clock 36 counts a current time.

The HDD 34 is a storage device that stores data. The HDD 34 stores a program that is executed by the processor 31 to realize the management function (temporary management function) of managing the deleted print job. Further, the HDD 34 includes a temporary storage region 34a that stores the job file indicating the details of the temporarily stored print job and a deleted job management table 34b that stores management information for the deleted job. In the system configuration shown in FIG. 1, the temporary storage region 34a stores the job file that is deleted from the print server 2 due to the expiration of the storage limit or the completion of the printing. The deleted job management table 34b stores the management information regarding the deleted job file that is stored in the storage region 34a.

FIG. 4 is a diagram illustrating an example of the structure of the deleted job management table 34b.

As shown in FIG. 4, a job ID, a user ID, a job file name, a copy number, a reception time, an option, and a temporary storage limit are stored for each deleted print job in association therewith in the deleted job management table 34b. The temporary storage limit is a limit at which the print job is completely deleted. The temporary storage limit is set to a time at which the print job is deleted and then the temporary storage limit expires.

For example, the temporary storage apparatus 3 or the print server 2 may set a time, in which a constant temporary storage period passes from the deletion of the print job, as the temporary storage limit. As for the printed print job, the time in which a first temporary storage period passes from the completion (transmission of the print job) of the printing may be set as a first temporary storage limit. As for the deleted print job deleted after the expiration of the storage limit, a time in which a second temporary storage period passes from the expiration of the storage limit may be set as a second temporary storage limit.

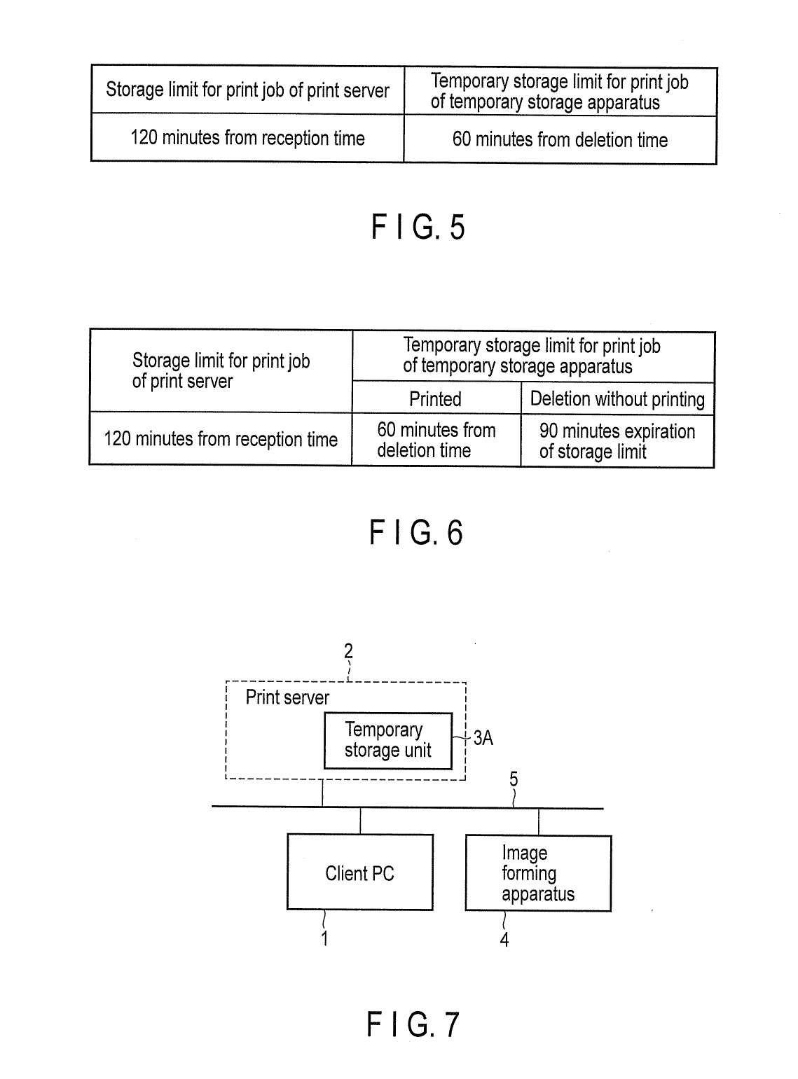

FIG. 5 is a diagram illustrating an example of first setting of the storage limit and the temporary storage limit. In the setting example shown in FIG. 5, a given temporary storage period is set in the deleted print job. In the setting example shown in FIG. 5, the storage limit is assumed to be 120 minutes from the reception time of the print job and the temporary storage limit is assumed to be 60 minutes from the deletion time of the print job.

FIG. 6 is a diagram illustrating an example of second setting of the storage limit and the temporary storage limit. In the setting example shown in FIG. 6, a temporary storage limit (first temporary storage limit) of the printed print job and a temporary storage limit (second temporary storage limit) of the print job for which the storage limit expires are separately set. In the setting example shown in FIG. 6, the storage limit is assumed to be 120 minutes from the reception time of the print job, the temporary storage limit (first temporary storage limit) of the printed print job is assumed to be a printing completion time (or a transmission time to the image forming apparatus 4 performing the printing) or 60 minutes, and the temporary storage limit (second temporary storage limit) of the print job for which the storage limit expires is assumed to be 90 minutes from the expiration time of the storage limit.

The first and second temporary storage limits are set in accordance with the operation form of the system. Alternatively, the first and second temporary storage limits may be set by the administrator of the system. For example, in an operation form in which the printed print job is reused, the first temporary storage limit is set to be longer than the second temporary storage limit. Thus, convenience for the reuse of the printed print job can be improved. Further, in an operation form in which the print job is frequently reused after the storage limit expires, the second temporary storage limit is set to be longer than the first temporary storage limit. Thus, even when the storage limit is set to be short, the print job can be temporarily stored during a long period after the expiration of the storage limit, thereby improving convenience.

Next, the configuration of the image forming apparatus 4 will be described.

As shown in FIG. 2, the image forming apparatus 4 includes a processor (CPU) 41, a RAM 42, a ROM 43, an HDD 44, a network interface (I/F) 45, a display unit 46, an operation unit 47, and a printer 48.

For example, the processor 41 is a CPU. The processor 41 realizes various kinds of processing functions by executing programs stored in the ROM 43 or the HDD 44. The RAM 42 is a main memory that functions as a working memory. The ROM 43 stores a control program, control data, or the like for controlling the operations of the image forming apparatus 4. The HDD 44 is a storage device that stores data. The network interface 45 is an interface that communicates with each of the print server 2 via the network 5.

The display unit 46 displays an operation guide or the like. The operation unit 47 is used when a user inputs information. The display unit 46 and the operation unit 47 are configured by an operation panel provided with a display device that has a hard key and a touch panel therein. When the PULL print is executed using the job file registered in the print server 2, the user inputs the user identification information through the operation unit 47 and instructs to perform printing using the job file corresponding to the user identification information acquired from the print sever 2.

The printer 48 forms image data included in the print data on a sheet with color or monochrome under the print condition included in the job file (print data). For example, the printer 48 is an electrophotographic image forming apparatus. However, the printer 48 is not limited to the electrophotographic image forming apparatus, but may be a type of image forming apparatus that forms an image with an inkjet or a thermal transfer.

Next, another example of the configuration of the image forming apparatus will be described.

FIG. 7 is a diagram schematically illustrating an example of a second configuration of the image forming system.

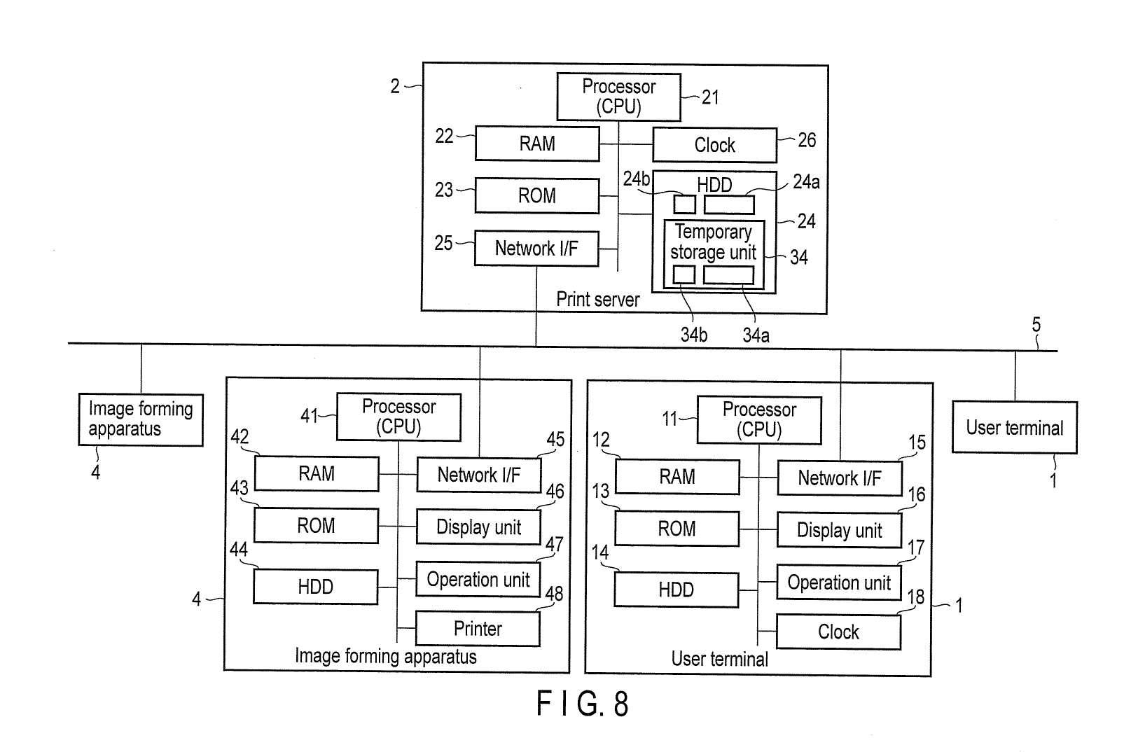

The image forming system shown in FIG. 7 further includes the temporary storage apparatus 3 and the print server 2 in addition to the configuration of the image forming system shown in FIG. 1. FIG. 8 is a block diagram illustrating an exemplary configuration of the control system of each apparatus of the image forming system shown in FIG. 7. In the image forming system with a second exemplary configuration shown in FIG. 7, the print server 2 has the function of the temporary storage apparatus 3 shown in FIG. 1 as a temporary storage unit 3A. That is, in the image forming system shown in FIG. 7, the print server 2 has the function (the temporary storage unit 3A) of storing and managing the deleted print jobs, as shown in FIG. 8. The image forming system with the second exemplary configuration shown in FIGS. 7 and 8 has the same function as the image forming system shown in FIGS. 1 and 2.

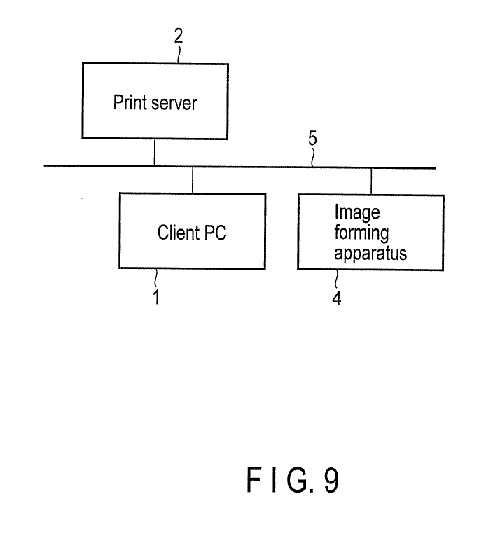

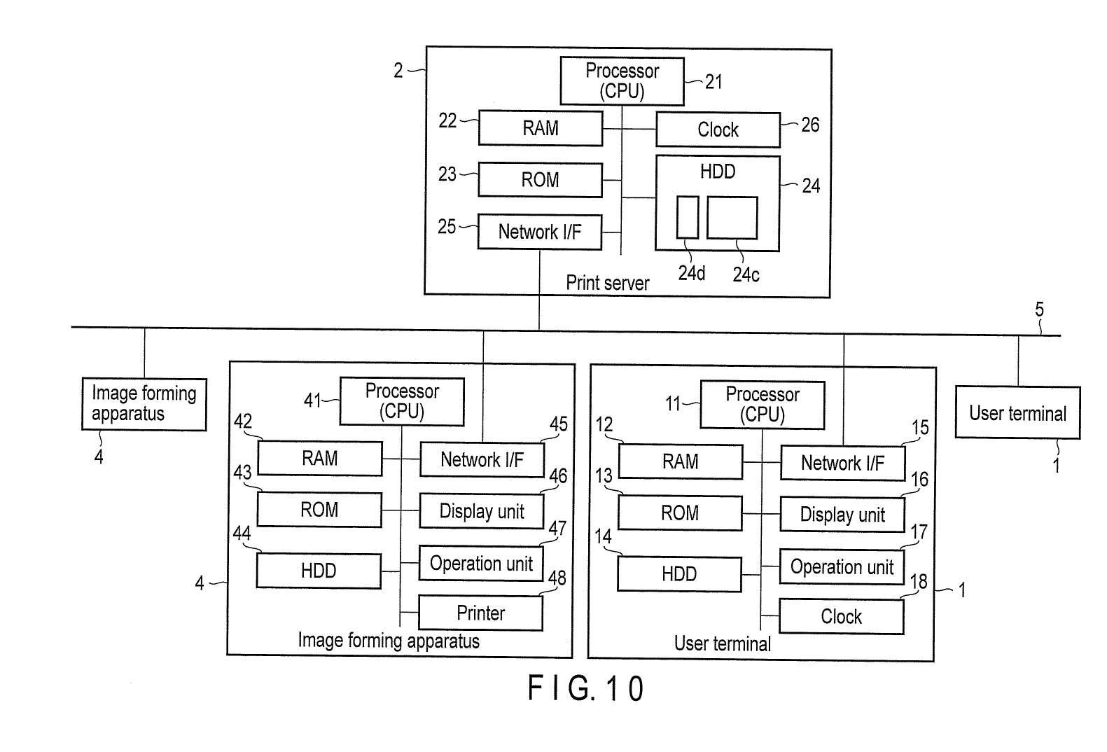

FIG. 9 is a diagram schematically illustrating a third exemplary configuration of the image forming system. FIG. 10 is a block diagram illustrating an example of the configuration of the control system of each apparatus in the image forming system shown in FIG. 9.

The image forming system shown in FIG. 9 has no temporary storage apparatus 3 of the image forming system shown in FIG. 1. The print server 2 shown in FIGS. 9 and 10 has a function of temporarily storing and managing the print jobs read to be printed (before deletion) and the deleted print jobs. That is, in the image forming system with the third exemplary configuration shown in FIG. 9, the print server 2 has a management function of managing not only the print jobs before the deletion but also the deleted print jobs.

That is, in the image forming system shown in FIGS. 9 and 10, the print server 2 stores the print jobs ready to be printed and the deleted print jobs in a single storage region 24c. Management information regarding each print job stored in the storage region 24c is stored in a single management table 24d. That is, in the image forming system with the third exemplary configuration, the print jobs deleted after the expiration of the storage limit and the printing are stored in the single storage region without movement of the job file between two storage regions and it is determined whether each job file is deleted or not using the management information stored in the management table 24d.

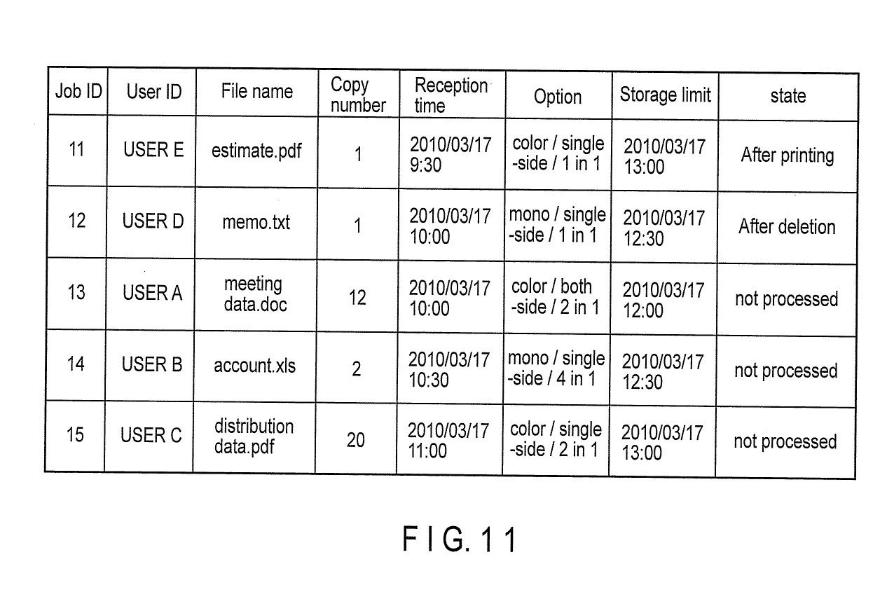

For example, FIG. 11 shows an example of the management table 24d in the print server 2 with the third exemplary configuration. In the management table 24d shown in FIG. 11, a job ID, a user ID, a job file name, a copy number, a reception time, an option, a storage limit (temporary storage limit), and state information are stored for each print job before and after deletion. The state information is information that indicates a state in which the print job is ready to be printed during the storage limit, a state (a state during the temporary storage limit after printing) in which the print job is deleted after the printing, or a state (a state during the temporary storage period after the expiration of the storage limit) in which the print job is deleted after the expiration of the storage limit. The storage limit is a temporary storage limit after printing for the printed print job, is a temporary storage limit after the expiration of the storage limit for the print job after the expiration of the storage limit, and is a predetermined storage limit for the print job during the storage limit.

In the following description, it is assumed that the image forming system has the first exemplary configuration. However, the management form for the deleted print job may be modified in the first exemplary configuration, the second exemplary configuration, and the third exemplary configuration. For this reason, each process described below is applicable to the image forming system with the second exemplary configuration and the third exemplary configuration.

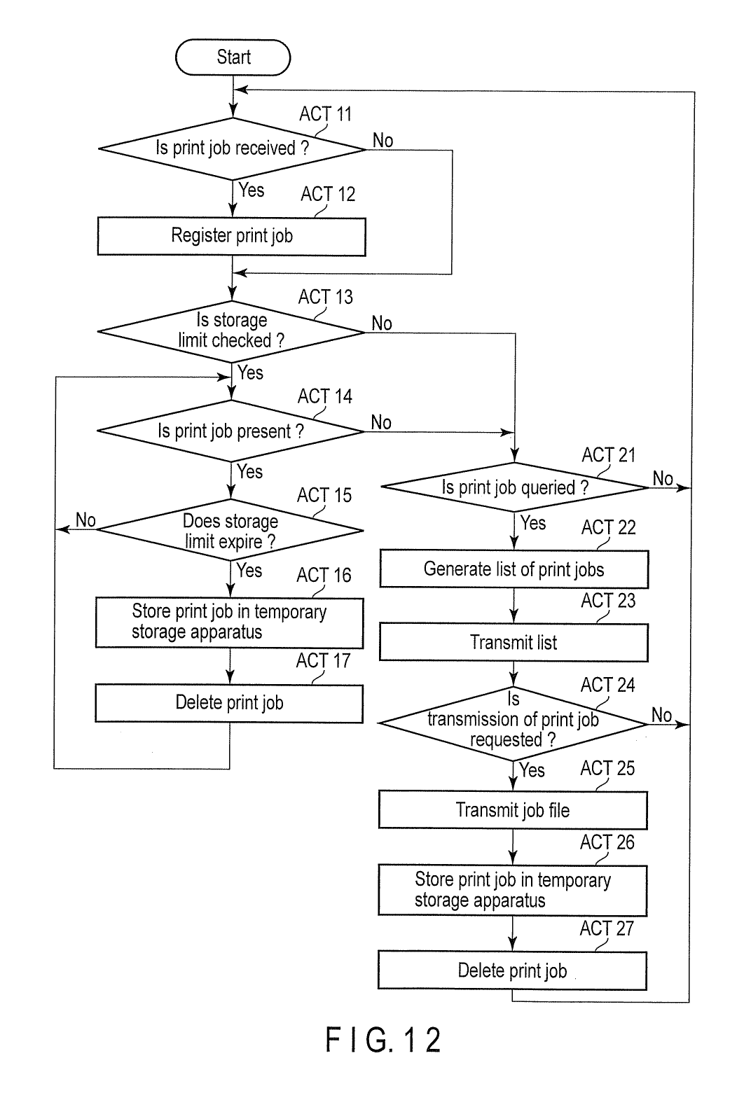

Next, management of the print jobs in the print server 2 will be described. FIG. 12 is a flowchart illustrating a process of managing print jobs in the print server 2.

The print sever 2 receives the job file from the client PC 1 and performs a job file registration process. That is, if the processor 21 of the print server 2 receives the job file of the PULL print from the client PC 1 via the network 5 (YES in ACT 11), the processor 21 performs the job file registration process (ACT 12). When the processor 21 receives the job file, the processor 21 of the print server 2 stores the job file received from the client PC 1 in the storage region 24a of the HDD 24. Further, the processor 21 of the print server 2 issues the job ID and stores the management information such as the user ID, the reception time of the job, the job file name, and the like associated with the issued job ID in the job management table 24b. The processor 21 calculates the storage limit for the print job from the reception time and the predetermined storage period for the job and registers the calculated storage limit in the job management table 24b in association with the print job.

The processor 21 of the print server 2 has a (automatic deletion process) function of checking the storage limit for each of the stored print jobs and deleting the print jobs for which the storage limit expires. For example, the processor 21 checks the storage limit for each print job at a predetermined time interval. If the processor 21 determines to check the storage limit (YES in ACT 13), the processor 21 determines whether the print job ready (before deletion) to be printed by the job management table 24b is present in the storage region 24a (ACT 14). If the processor 21 determines that no print job is present (NO in ACT 14), the processor 21 ends the checking (automatic deletion process) of the storage limit.

On the other hand, if the processor 21 determines that the print job ready to be printed is present (YES in ACT 14), the processor 21 determines whether the storage limit stored in the job management table 24b expires for one print job ready to be printed (ACT 15). If the processor 21 determines that the storage limit does not expire (NO in ACT15), the process returns to ACT 14 and the processor 21 checks the storage limit when the print job ready to be printed is present. When no print job ready to be printed is present, the processor 21 ends the checking (automatic deletion process) of the storage limit.

If the processor 21 determines that the storage limit for the print job ready to be printed expires (YES in ACT15), the processor 21 moves the print job to the temporary storage apparatus 3 (ACT 16 and ACT 17). When the processor 21 moves the print job for which the storage limit expires, the processor 21 transmits the print job as the print job to be temporarily stored after expiration of the storage limit to the temporary storage apparatus 3 (ACT 16). Then, the processor 21 deletes the file of the print job from the storage region 24a and also deletes the management information regarding the print job from the job management table 24b (ACT 17). When the movement of the print job for which the storage limit expires is completed, the process returns to ACT 14 and the processor 21 checks the storage limit when another print job ready to be printed is present. When no print job ready to be printed is present, the processor 21 ends the checking (automatic deletion process) of the storage limit.

The print server 2 also has a function of transmitting the list of the print jobs ready to be printed in response to the query for the print job to the image forming apparatus 4. That is, the processor 21 of the print server 2 receives a query for the print job from each image forming apparatus 4 (ACT 21). If the processor 21 receives the query for the print job ready to be printed from the image forming apparatus 4 (YES in ACT 21), the processor 21 generates the list of the queried print jobs ready to be printed (ACT 22). The processor 21 transmits the generated list of the print jobs to the image forming apparatus 4 which is a query source (ACT 23).

The print server 2 also has a function of transmitting the print job to the image forming apparatus 4 in response to a transmission request for the print job to be printed. That is, the processor 21 of the print server 2 receives the transmission request (print request) for the print job to be printed from each image forming apparatus 4 (ACT 24). If the processor 21 receives the transmission request for the print job from the image forming apparatus 4 (YES in ACT 21), the processor 21 reads the print job requested to be transmitted from the storage region 24a and transmits the print job to the image forming apparatus 4 which is a transmission request source (ACT 25).

When the processor 21 transmits the print job to the image forming apparatus 4 (or when the processor 21 receives notification of the printing completion of the print job from the image forming apparatus 4), the processor 21 performs a process of moving the print job to the temporary storage apparatus 3 (ACT 26 and ACT 27). When the processor 21 performs the process of moving the printed print job, the processor 21 transmits the print job as the printed print job to be temporarily stored to the temporary storage apparatus 3 (ACT 26). Then, the processor 21 deletes the file of the print job from the storage region 24a and deletes the management information of the print job from the job management table 24b (ACT 27).

Thus, the print server 2 manages the print job during the storage limit and transmits the print job for which the storage limit does not expire in response to the print request from any image forming apparatus 4. In this way, the print server 2 can make any image forming apparatus 4 realize the print (PULL print).

Next, management of the deleted print job in the temporary storage apparatus 3 will be described.

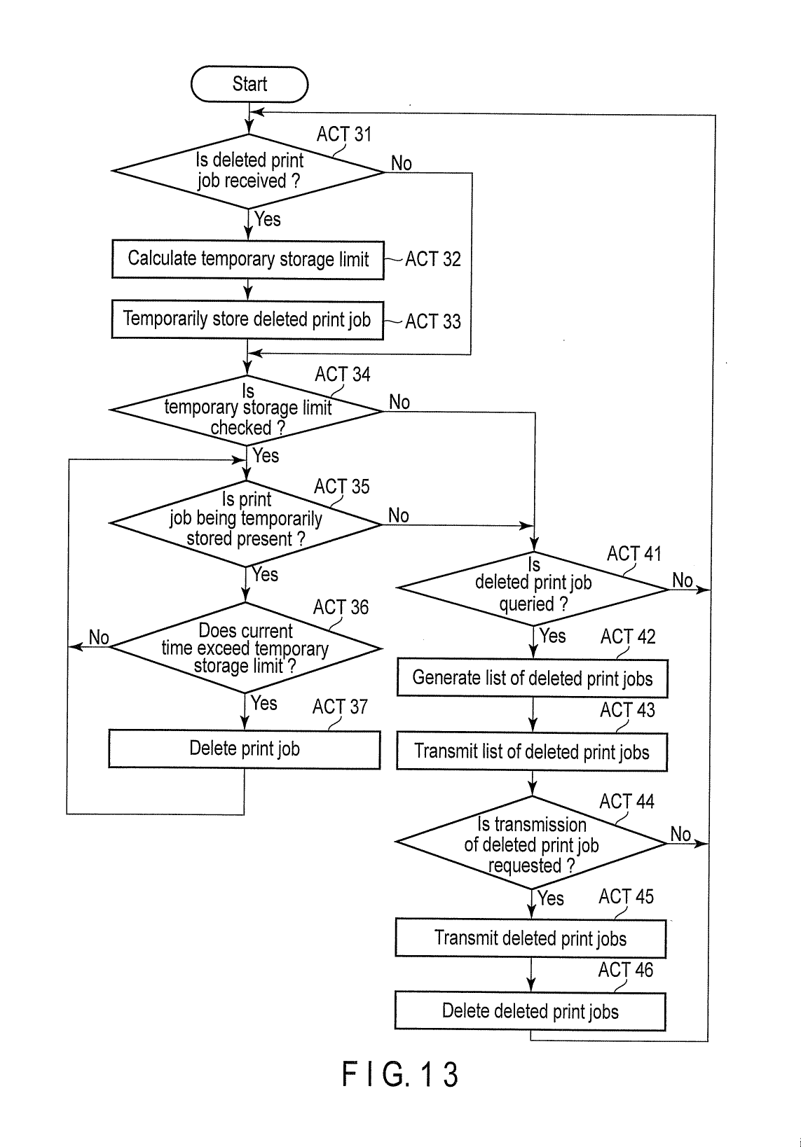

FIG. 13 is a flowchart illustrating a process of managing the deleted print jobs in the temporary storage apparatus 3.

First, a process (temporary storage process) of registering the deleted print jobs in the temporary storage apparatus 3 will be described. The temporary storage apparatus 3 has a function of receiving the job file deleted from the print server 2 and temporarily storing the received deleted job file. For example, the temporary storage apparatus 3 receives, as the deleted job files, the job file for which the storage limit expires and the printed job file from the print server 2 via the network 5.

If the temporary storage apparatus 3 receives the deleted job file from the print server 2 (YES in ACT 31), the processor 31 of the temporary storage apparatus 3 stores the received deleted job file in the storage region 34a of the HDD 34. The processor 21 calculates the temporary storage limit corresponding to the print job from the time (for example, a time of receiving the printed job) of deleting the print job and a period in which the print job is temporarily stored (ACT 32). When the processor 31 calculates the temporary storage limit, the processor 31 stores, as the management information regarding the received deleted job file, the job ID, the user ID, the reception time of the job, the job file name, and the temporary storage limit in the deleted job management table 34b (ACT 33).

For example, when the given temporary storage period is set for the deleted print job, the processor 31 calculates the temporary storage limit from the deletion time (for example, a time at which the temporary storage apparatus 3 receives the print job) of the print job and the temporary storage period. Further, when the first temporary storage period is set for the printed print job, the processor 31 sets the first temporary storage limit for the print job (the printed print job) from a print execution time (for example, a transmission time of the print job from the print server 2 to the image forming apparatus 3) and the first temporary storage period, for the print job deleted after the printing.

Furthermore, when the second temporary storage period is set for the print job for which the storage limit expires, the processor 31 calculates the second temporary storage limit for the print job (the print job for which the storage limit expires) from the deletion time (for example, a time at which the temporary storage apparatus 3 receives the print job) of the print job and the second temporary storage period, for the print job deleted after the printing.

The temporary storage apparatus 3 has a function of checking the temporary storage limit for each print job and deleting the print job for which the storage limit expires. For example, the processor 31 checks the temporary storage limit for each print job at a predetermined time interval. If the processor 31 determines to check the temporary storage limit (YES in ACT 34), the processor 31 determines whether the deleted print job is present as the print job being temporarily stored in the deleted job management table 34b in the storage region 34a (ACT 35). If the processor 31 determines that no print job being temporarily stored is present (NO in ACT 35), the processor 21 ends the checking (automatic deletion process) of the temporary storage limit.

On the other hand, if the processor 31 determines that the print job being temporarily stored is present (YES in ACT 35), the processor 31 determines whether the current time counted by the clock 36 exceeds the temporary storage limit stored in the deleted job management table 34b for a single print job being temporarily stored (ACT 36). If the processor 21 determines that the current time does not exceed the temporary storage limit (NO in ACT 36), the process returns to ACT 35. When the print job being temporarily stored is present, the processor 21 checks the temporary storage limit. When no print job being temporarily stored is present, the processor 21 ends the checking (automatic deletion process) of the temporary storage limit.

On the other hand, if the processor 21 determines that the current time exceeds the temporary storage limit (YES in ACT 36), the processor 21 deletes the print job from the storage region 34a and deletes the management information of the print job from the deleted management table 34b in order to delete the print job (ACT 37). When the print job of which the temporary storage limit expires is deleted, the process returns to ACT 34. When another print job being temporarily stored is present, the processor 21 checks the temporary storage limit. When no print job being temporarily stored is present, the processor 21 ends the checking (automatic deletion process) of the temporary storage limit.

The temporary storage apparatus 3 has a function of transmitting the list of the print jobs being temporarily stored to the image forming apparatus 4 in response to a query for the deleted print job. That is, the processor 31 of the temporary storage apparatus 3 receives the query for the deleted print job from each image forming apparatus 4 (ACT 41). If the processor 31 receives a query for the print job being temporarily stored from the image forming apparatus 4 (YES in ACT 41), the processor 31 generates the list of the queried deleted print jobs (ACT 42). The processor 31 transmits the generated list of the print jobs to the image forming apparatus 4 which is a query source (ACT 43).

The temporary storage apparatus 3 has a function of transmitting the print job to the image forming apparatus 4 in response to a transmission request (print request) for the deleted print job. That is, the processor 31 of the temporary storage apparatus 3 receives a transmission request (print request) for the deleted print job to be printed from each image forming apparatus 4 (ACT 44). If the processor 21 receives the transmission request for the deleted print job from the image forming apparatus 4 (YES in ACT 44), the processor 21 reads the deleted print job requested to be transmitted from the storage region 34a and transmits the deleted print job to the image forming apparatus 4 which is a transmission request source (ACT 45).

When the deleted print job is transmitted to the image forming apparatus 4 in response to the transmission request (or when the processor 31 receives a notification of the printing completion of the deleted print job from the image forming apparatus 4), the processor 31 deletes the job file of the print job from the storage region 34a and also delete the management information regarding the print job from the management table 34b (ACT 46).

Next, a process of printing the print job and the deleted print job in the image forming apparatus 4 will be described.

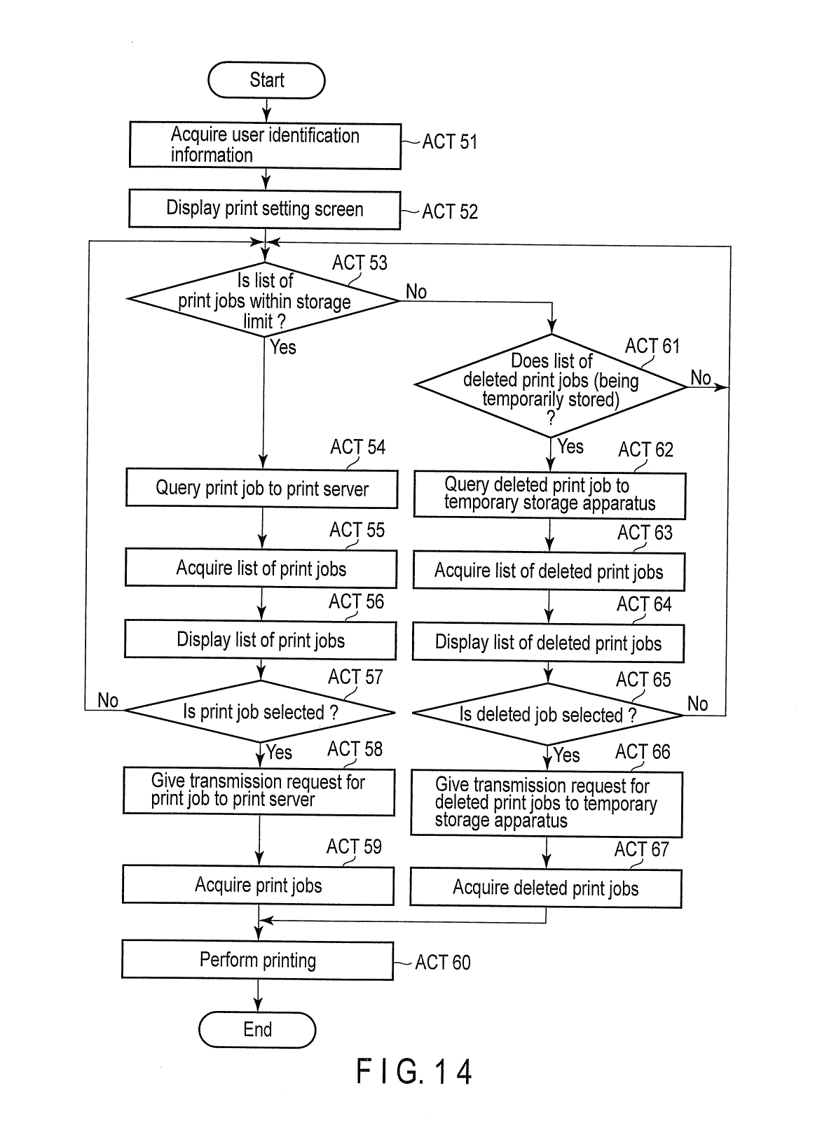

FIG. 14 is a flowchart illustrating the process of printing the print jobs and the deleted print jobs in the image forming apparatus 4.

A user registering the print job for the PULL print in the print server 2 executes the print job in any image forming apparatus 4. The processor 41 of the image forming apparatus 4 performing the PULL print acquires information (user identification information) used to identify the user which is an operator (ACT 51). The processor 41 may acquire the user identification information input through the operation unit 47 of the image forming apparatus 4 by the user or may acquire the user identification information through user authentication using authentication information stored in a recording medium such as an ID card or authentication information such as biological information.

When the processor 41 acquires the user identification information, the processor 41 displays a print setting screen for the PULL print on the display unit 46 in response to a user operation (ACT 52). The processor 41 displays the list of the normal print jobs (print jobs within the storage limit) or the list of the deleted print jobs (print jobs being temporarily stored) on the display unit 46 in response to a user operation.

For example, if the user instructs to display the list of the normal print jobs (YES in ACT 53), the processor 41 transmits the query for the print job executable by the user to the print server 2 through the network interface 45 (ACT 54). The processor 41 of the image forming apparatus 4 receives the list of the print jobs transmitted from the print server 2 in response to the query through the network interface 45 (ACT 55).

When the processor 41 acquires the list of the normal print jobs, the processor 41 displays the acquired list of the print jobs on the display unit 46 (ACT 56). For example, the user selects one print job to be printed from the list of the print jobs displayed on the display unit 46 by a touch panel serving as the operation unit 47. If the user selects the print job (YES in ACT 57), the processor 41 transmits the transmission request (print request) for the selected print job to the print server 2 (ACT 58). The processor 41 of the image forming apparatus 4 receives the job file of the print job transmitted from the print server 2 in response to the transmission request through the network interface 45 (ACT 59). When the processor 41 acquires the print job, the processor 41 makes the printer 48 perform printing based on the received print job (ACT 60).

If the user instructs to display the list of the deleted print jobs (being temporarily stored) (YES in ACT 61), the processor 41 transmits the query for the deleted print job printable by the user to the temporary storage apparatus 3 through the network interface 45 (ACT 62). The processor 41 of the image forming apparatus 4 receives the list of the print jobs transmitted from the temporary storage apparatus 3 in response to the query through the network interface 45 (ACT 63).

When the processor 41 acquires the list of the deleted print jobs, the processor 41 displays the acquired list of the deleted print jobs on the display unit 46 (ACT 64). For example, the user selects one deleted print job to be printed from the list of the deleted print jobs displayed on the display unit 46 by the touch panel serving as the operation unit 47. If the processor 41 receives an instruction to print the deleted print job (YES in ACT 65), the processor 41 transmits the transmission request (print request) for the selected deleted print job to the temporary storage apparatus 3 (ACT 66). The processor 41 of the image forming apparatus 4 receives the job file of the print job transmitted from the temporary storage apparatus 3 in response to the transmission request through the network interface 45 (ACT 67). When the processor 41 acquires the print job, the processor 41 makes the printer 48 perform the printing process based on the received print job (ACT 60).

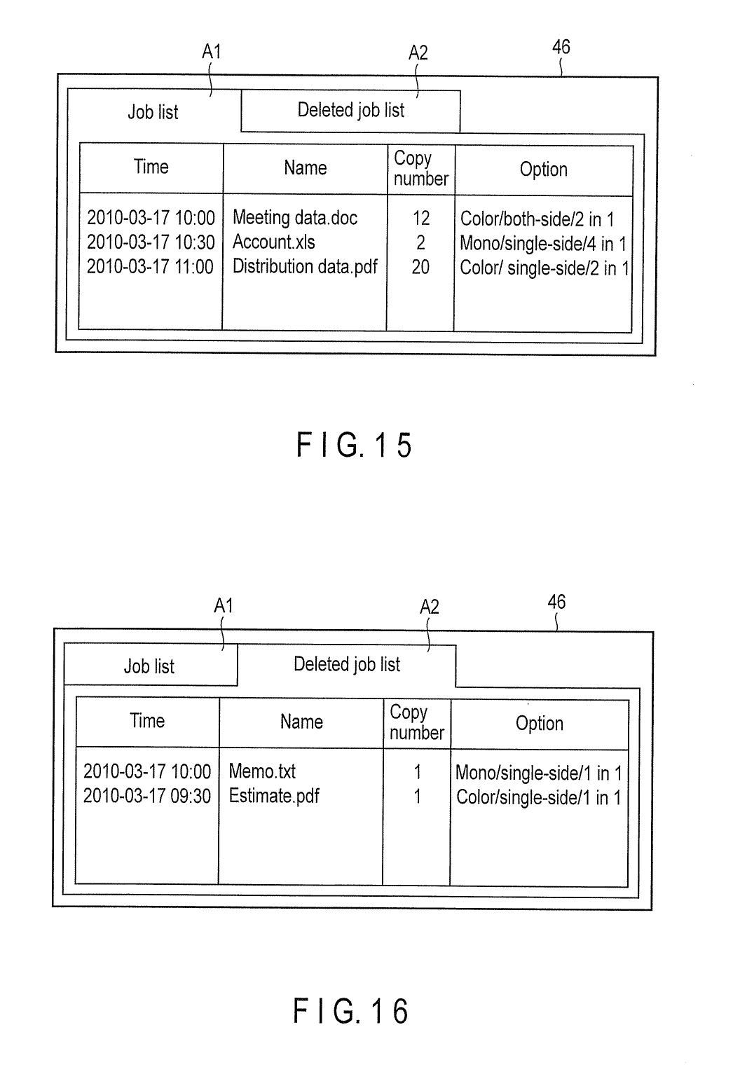

FIGS. 15 to 20 are diagrams illustrating display examples of the normal print jobs and the deleted print jobs.

In FIG. 15, a first display example of the list of the normal print jobs acquired from the print server 2 is displayed on the display unit 46. In FIG. 16, the first display example of the list of the deleted print jobs acquired from the temporary storage apparatus 3 is displayed on the display unit 46. In the first display example shown in FIGS. 15 and 16, the display unit 46 displays a tab A1 for displaying a “job list” and a tab A2 for display a “deleted job list”.

FIG. 15 shows the display example of the list of the normal print jobs displayed when the tab A1 for displaying the “job list” is selected. FIG. 16 shows the display example of the list of the deleted print jobs displayed when the tab A2 for displaying the “deleted job list” is selected. That is, the display unit 46 displays the list of the normal print jobs shown in FIG. 15 and the list of the deleted print jobs shown in FIG. 16 in a switching manner, whenever the tab A1 for displaying the “job list” and the tab A2 for displaying the “deleted job list” are instructed.

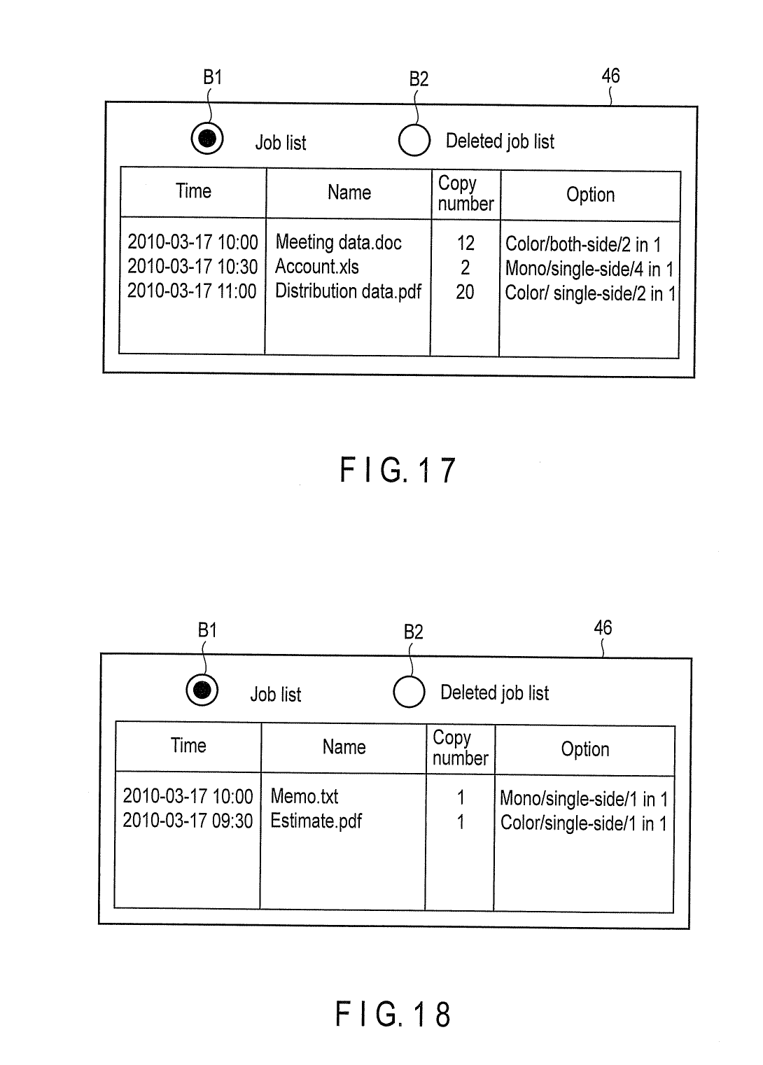

In FIG. 17, a second display example of the list of the normal print jobs acquired from the print server 2 is displayed on the display unit 46. In FIG. 18, the second display example of the list of the deleted print jobs acquired from the temporary storage apparatus 3 is displayed on the display unit 46. In the second display example shown in FIGS. 17 and 18, the display unit 46 displays a button B1 for instructing display of the list of the normal print jobs and a button B2 for instructing the display of the list of the deleted print jobs.

FIG. 17 shows the display example of the list of the normal print jobs displayed when the button B1 is selected. FIG. 18 shows the display example of the list of the deleted print jobs displayed when the button B2 is selected. That is, the display unit 46 displays the list of the normal print jobs shown in FIG. 17 and the list of the deleted print jobs shown in FIG. 18 in a switching manner, whenever the button B1 and the button B2 are instructed.

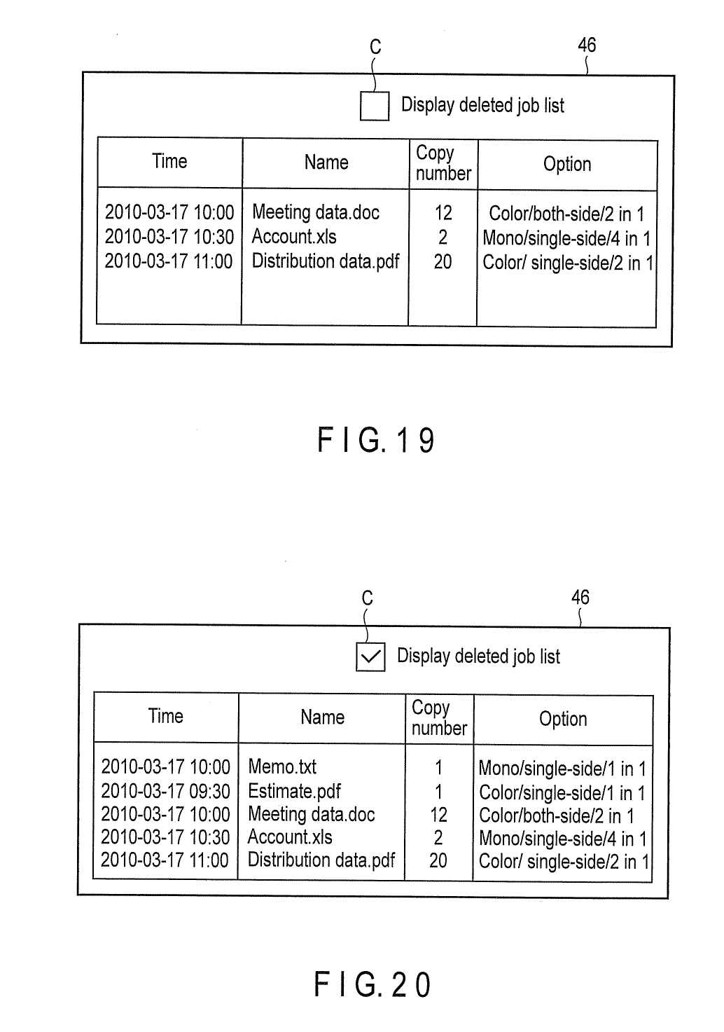

In FIG. 19, a third display example of the list of the normal print jobs acquired from the print server 2 is displayed on the display unit 46. In FIG. 20, the third display example of the list of the normal print jobs acquired from the print server 2 and the deleted print jobs acquired from the temporary storage apparatus 3 is displayed on the display unit 46. In the third display example shown in FIGS. 19 and 20, the display unit 46 displays a toggle switch C for switching a display of only the list of the normal print jobs and a display of the list of the normal print jobs and the list of the deleted jobs.

FIG. 19 shows the display example of the list of the normal print jobs displayed when the toggle switch C is not selected. FIG. 20 shows the display example of the list of the normal print jobs and the list of the deleted jobs displayed when the toggle switch C is selected. That is, the display unit 46 switches the display of only the list of the normal print jobs, as shown in FIG. 19 and the display of the list of the normal print jobs and the list of the deleted jobs, as shown in FIG. 20, by selection and non-selection of the toggle switch C.

In the image forming system according to this embodiment, as described above, the registered print jobs are managed during the predetermined storage limit, and the temporary storage limit is set in the print jobs of which the storage limit expires and the printed print jobs so as to be temporarily stored. Within the temporary storage limit, the image forming apparatus can print the print job for which the storage limit expires and the printed print job. As a consequence, in this image forming system, the storage limit is practically extended without changing the storage limit for the print jobs in the print server and flexibly operation can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus comprising:
a storage unit which stores print jobs received from an external apparatus;
a communication unit which transmits the print job stored in the storage unit, in response to a print request for the print job from any image forming apparatus, to the image forming apparatus which is a print request source; and
a controller which changes the print job of which a storage limit expires among the print jobs stored in the storage unit into a deleted print job which is stored during a temporary storage limit.

2. The apparatus according to claim 1, wherein the controller changes the print job transmitted to the image forming apparatus by the communication unit into the deleted print job stored during the temporary storage limit.

3. The apparatus according to claim 2, wherein the controller stores the deleted print job for which the storage limit expires so as to have a first temporary storage limit and stores the deleted print job transmitted to the image forming apparatus so as to have a second temporary storage limit.

4. The apparatus according to claim 1, wherein the controller deletes the print job for which the storage limit expires from the storage unit and transmits the print job deleted from the storage unit as the deleted print job to the temporary storage apparatus that stores the deleted print job during the temporary storage limit.

5. The apparatus according to claim 4, wherein the controller deletes the print job transmitted to the image forming apparatus from the storage unit and transmits the print job deleted from the storage unit as the printed print job to the temporary storage apparatus that stores the temporary storage limit.

6. The apparatus according to claim 1, further comprising:
a temporary storage unit which stores the deleted print job during the temporary storage limit,
wherein the controller deletes the print job for which the storage limit expires from the storage unit and stores the print job deleted from the storage unit as the deleted print job in the temporary storage unit.

7. The apparatus according to claim 6, wherein the controller deletes the print job transmitted to the image forming apparatus from the storage unit and stores the print job deleted from the storage unit as a printed print job in the temporary storage unit.

8. The apparatus according to claim 7, wherein the controller stores the deleted print job for which the storage limit expires during a first temporary storage limit in the temporary storage unit and stores the printed print job during a second temporary limit in the temporary storage unit.

9. The apparatus according to claim 1, further comprising:
a management information storage unit which stores information indicating the print job stored in the storage unit and management information corresponding to state information indicating whether the print job is in a deleted state in association therewith,
wherein the controller manages the print job of which the state information is not in the deleted state during the storage limit, manages the print job of which the state information is in the deleted state during the temporary storage limit, and changes, into the deleted state, the state of the print job for which the storage limit expires among the print jobs that are not deleted.

10. The apparatus according to claim 9, wherein the controller changes the state information of the print job transmitted to the image forming apparatus into the deleted state.

11. The apparatus according to claim 10,
wherein the state information indicates a deleted state in which the storage limit expires and a deleted state in which printing ends, and
wherein the controller manages, during a first temporary storage limit, the deleted print job in the deleted state where the storage limit expires, and manages, during a second temporary storage limit, the deleted print job in the deleted state in which the printing ends.

12. An image forming system comprising:
a server apparatus includes
a storage unit which stores print jobs received from an external apparatus;
a communication unit which transmits the print job stored in the storage unit, in response to a print request for the print job from any image forming apparatus, to the image forming apparatus which is a print request source; and
a controller which moves the print job of which a predetermined storage limit expires among the print jobs stored by the storage unit to a temporary storage apparatus that stores the print job as a deleted print job during a temporary storage limit, and
an image forming apparatus includes
a communication unit which receives the print job stored during the storage limit in the storage unit or the deleted print job stored in the temporary storage apparatus, and
a printer which performs printing based on the print job stored during the storage limit or the deleted print job received by the communication unit.

13. The system according to claim 12,
wherein the image forming apparatus further includes
a display unit which displays a list of the deleted print jobs, and
an operation unit which selects one deleted print job from the list of the deleted print jobs displayed on the display unit,
wherein the communication unit receives the deleted print job selected by the operation unit.

14. The system according to claim 13,
wherein the image forming apparatus further includes
a button which instructs to display the list of the deleted print jobs, and
an acquisition unit which acquires the list of the deleted print jobs from the temporary storage apparatus, when the button receives an instruction, and
wherein the display unit displays the list of the deleted print jobs acquired by the acquisition unit.

15. The system according to claim 13, wherein the display unit of the image forming apparatus displays a mixed list of normal print jobs and the deleted print jobs.

16. A method of managing image forming data, comprising:
storing print jobs by a server apparatus;
changing the print job of which a predetermined storage limit expires among the print jobs stored by the server apparatus into a deleted print job stored during a temporary storage limit;
transmitting the deleted print job stored during the temporary storage limit to a printer; and
performing printing based on the deleted print job by the printer.

17. The method according to claim 16, further comprising:
changing the print job transmitted to the image forming apparatus into the deleted print job stored during the temporary storage limit.

18. The method according to claim 16, further comprising:
deleting the print job for which the storage limit expires among the print jobs stored by the server apparatus; and
transmitting the print job deleted from the server apparatus as the deleted print job to the temporary storage apparatus that stores the deleted print job during the temporary storage limit.

19. The method according to claim 16, further comprising:
storing the print job of which the storage limit does not expire in the storage unit;
deleting the print job for which the storage limit expires from the storage unit; and
storing the print job deleted from the storage unit as the deleted print job in the temporary storage unit.

20. The method according to claim 16, further comprising:
storing information indicating the print job stored by the server apparatus and management information corresponding to state information indicating whether the print job is in a deleted state in association therewith;
managing the print job of which the state information is not in the deleted state during the storage limit;
managing the print job of which the state information is in the deleted state during the temporary storage limit; and
changing, into the deleted state, the state of the print job for which the storage limit expires among the print jobs that are not deleted.
